(19) United States
(12) Patent Application Publication
(10) Pub. No.: US 2009/0168778 A1
(43) Pub. Date: Jul. 2, 2009

(54) EXTENDING COMMUNICATION PROTOCOLS

(76) Inventors: Zulfiqar Ahmed, Cottingham (GB); Donal Lafferty, Cambridge (GB)

Correspondence Address: MG-IP Law, PLLC, PO BOX 1364, FAIRFAX, VA, 22038-1364, US

(21) Appl. No.: 11/966,687

(22) Filed: Dec. 28, 2007

(51) Int. Cl. H04L 12/28

(52) U.S. Cl. 370/392

(57) ABSTRACT

The invention provides a method of transmitting data in a communication network comprising a first node and a second node. The method comprises initiating a communication session according to a first predetermined communication standard, wherein the first predetermined communication standard is a session-based protocol for establishing and controlling media sessions. The method further comprises transmitting from the first node to the second node, within the session, a first message comprising a header portion and a body portion, the header portion being configured according to the first predetermined communication standard. The body portion comprises data configured according to a second communication standard, the second communication standard providing a schema for creating methods of requesting service functions.

### FIELD OF THE INVENTION

The present invention relates to the extensibility of communication protocols, and particularly to the extensibility of session based protocols such as the Session Initiation Protocol.

### BACKGROUND

Session Initiation Protocol (SIP) is an Internet Engineering Task Force (IETF) application-layer protocol for creating, modifying, controlling and terminating communication sessions. It is especially suited to media sessions such as video, audio and Voice over IP (VoIP). It can also be used for providing presence services and instant messaging. Such capabilities will be familiar to a person skilled in the art.

SIP operates on a request-response basis. The SIP requests are sometimes also referred to as “methods”, although that terminology is not used from hereon in for the purposes of this application. These SIP request are analogous to verbs, in the sense that they request some predetermined type of action to be taken. The standardized SIP requests types are: INVITE, REGISTER, BYE, ACK, CANCEL, OPTIONS, REFER, SUBSCRIBE, NOTIFY, MESSAGE, UPDATE and INFO.

SIP request messages are divided into two portions, a header portion and a body portion. The header portion can be considered as sub-divided into two portions. The header starts with a request portion defining the nature of the request and a further header portion containing other general header information such as, a source address, destination address, call-ID and so forth. The body of a SIP message is optional and may contain MIME-encoded data. If included, MIME headers and the body length are described in the header portion of the message. The body is MIME-encoded. Media, codec, and sampling rate data is included in the body when setting up a media session, and this data is encoded using the application/SDP data type.

Although SIP is well suited for providing media sessions, instant messaging sessions and presence services, it is not so well suited to handling business data, business services and web services. This is because SIP only defines an exhaustive list of request types which does not include types that can currently handle the diverse functions that would be required to provide business and web services. Moreover, SIP does not establish a standard grammar for accessing business services. Existing SIP request types are focused on the establishment and maintenance of sessions, and SIP header extensions lack any standard explaining how they are used to access services. It would be advantageous to extend the functionality of the SIP protocol or other session-based protocols in order to include functionality suitable for such services while remaining consistent and compatible with existing specifications.

The traditional method of extending the SIP protocol is to devise new types of header portions for SIP request messages, either in the request portion of the header or the general portion of the header. However, this is impractical since it means breaking with the industry standard. Only systems that have been configured to recognise and operate according to the new header type can take advantage of the new functionality. If the extended protocol is to be of any practical use, it is necessary to agree upon a new industry standard. Of course, users will demand that different systems can communicate with one another and so standardization is essential, but agreeing upon new communication standards is an inefficient and time-consuming process because consensus is required for a group of manufacturers, service providers and/or network operators to support new request types in their equipment and/or software.

For completeness, note the distinction between the introduction of new request portions and other new header portions. Request types must be recognized by a SIP user agent (UA), or the message will be discarded. Other header modifications can be used in conjunction with existing request types, but there are no standards governing how a header would be used to express the service being accessed and the data required for service access. Ad hoc solutions lack interoperability with business service/web service standards.

US published application no. 2006-0090166 discloses one option for extending the functionality of SIP by introducing Internet Protocol Terminal Mark-up Language (IPTML) protocol into the body of a SIP message. However, IPTML is too rigid to provide an adequate extensibility of the SIP protocol since IPTML only specifies some very specific predetermined commands. Further, IPTML is only suited to “user-system” interactions, such as between a user terminal and a server. IPTML addresses only a specific service, which is the interaction of a phone user with a telephone. Therefore there still exists a need to provide extended “system-system” interactions such as between two servers, and also to improve the flexibility of extensions.

An IETF draft (http://www.softarmor.com/wgdb/docs/draft-deason-sip-soap-00.txt, “SIP and SOAP”, N. Deason, 30 Jun. 2000, expired December 2000) has proposed that the Simple Object Access Protocol could be combined with SIP. However, this document teaches that in order to transport SOAP, a new type of non-standard “SERVICE” request must be introduced. The SERVICE request has not been adopted in SIP.

Further background in this field can be found in another IETF draft, http://mirrors.isc.org/pub/www.watersprings.org/pub/id/draft-deason-sipping-soap-sessions-00.txt, “SIP for SOAP sessions” N. Deason, 23 April, expired October 2002.

What is needed is a way of extending the SIP protocol to introduce additional, flexible functionality into SIP sessions without having to break with industry standards, and without new industry standards having to be introduced. Preferably this additional functionality should provide improved functionality for system-system interactions, especially with regard to improving business and web services.

### SUMMARY OF THE INVENTION

The inventors have recognised that, contrary to the teachings of the above 2000 IETF draft, SOAP vocabulary can be included in the body of a standard SIP message without the need for non-standardized modification to the header or request portion of the message.

According to one aspect of the present invention, there is provided a method of transmitting data in a communication network comprising a first node and a second node, the method comprising: initiating a communication session according to a first predetermined communication standard, wherein the first predetermined communication standard is a session-based protocol for establishing and controlling media sessions; and transmitting from the first node to the second node, within said session, a first message comprising a header portion and a body portion, the header portion being configured according to the first predetermined communication standard; wherein the body portion comprises data configured according to a second communication standard, the second communication standard providing a schema for creating methods of requesting service functions.

Said first node may be configured according to the predetermined settings of a first provider and said second node may be configured according to the predetermined settings of a second provider, wherein each of said first provider and said second provider is one of a manufacturer, a network operator and a network service provider; and wherein said predetermined settings are such that each of said first node and said second node is configured to recognise both said first communication standard and said second communication standard.

Said first predetermined communication standard may define a message of a predetermined type and said first message may be a message of that predetermined type.

The second node may be configured to be instructed, upon detecting any message to be of said predetermined type, to refer to the body of said any message for generic information, the referral being independent of the content of the body of said any message.

The method may comprises a step of transmitting a second message of said predetermined type, the second message comprising a header portion and a body portion, wherein the body of the second message does not comprise data configured according to said second communication standard.

The header portion of the first message may comprise a request portion defining the request type and a further header portion containing additional header information.

Each of the first and second nodes may comprise a server.

The method may further comprise a step of ending said session by transmitting an end message of the first communication protocol, the transmission of the end message defining the end of the session.

The first communication standard may be an application-layer protocol. The first communication standard may be a session-based protocol for establishing and controlling at least one of a voice session and a video session. The session that is established may be one of a voice session and a video session. The first communication standard may be Session Initiation Protocol (SIP).

The second communication standard may provides a specification for creating methods of requesting services, including for defining how to encode data parameters required to interact with a service. The second communication standard may be Simple Object Access Protocol (SOAP).

Said predetermined message type may be an INFO message type. Said predetermined message type may be a MESSAGE message type. Said predetermined message may be one of the following message types: INVITE, REGISTER, BYE, ACK, CANCEL, OPTIONS, REFER, SUBSCRIBE, NOTIFY, MESSAGE, UPDATE and INFO.

According to another aspect of the present invention, there is provided a first network element for transmitting data over a communication network to second network element, the first network element being arranged to: initiate a communication session according to a first predetermined communication standard by transmitting an invitation message to the second network element, wherein the first predetermined communication standard is a session-based protocol for establishing and controlling media sessions; and transmit to the second network element, within said session, a first message comprising a header portion and a body portion, the header portion being configured according to the first predetermined communication standard; wherein the first network element is further arranged to insert data configured according to a second communication standard into said body portion prior to transmission, the second communication standard providing a schema for creating methods of requesting service functions.

According to another aspect of the present invention, there is provided a second network element for receiving data over a communication network from a first network element, the second network being arranged to: join a communication session according to a first predetermined communication standard upon receipt of an invitation message from the first network element, wherein the first predetermined communication standard is a session-based protocol for establishing and controlling media sessions; and receive from the first network element, within said session, a first message comprising a header portion and a body portion, the header portion being configured according to the first predetermined communication standard; wherein the body portion comprises data configured according to a second communication standard, the second communication standard providing a schema for creating methods of requesting service functions; and the second network element is arranged to extract the data configured according to the second communication standard.

The second network element may comprise a first stack configured according to the first predetermined communication standard and a second stack configured according to the second predetermined communication standard, wherein the second network element is configured to provide a binding between the first stack and the second stack.

Thus the present invention advantageously allows the functionality of session based protocols such as SIP to be extended without breaking with industry standards, and without requiring industry-wide consensus on new standards.

### DETAILED DESCRIPTION

For a better understanding of the present invention and to show how the same may be carried into effect, reference will now be made, by way of example, to the corresponding drawings in which:

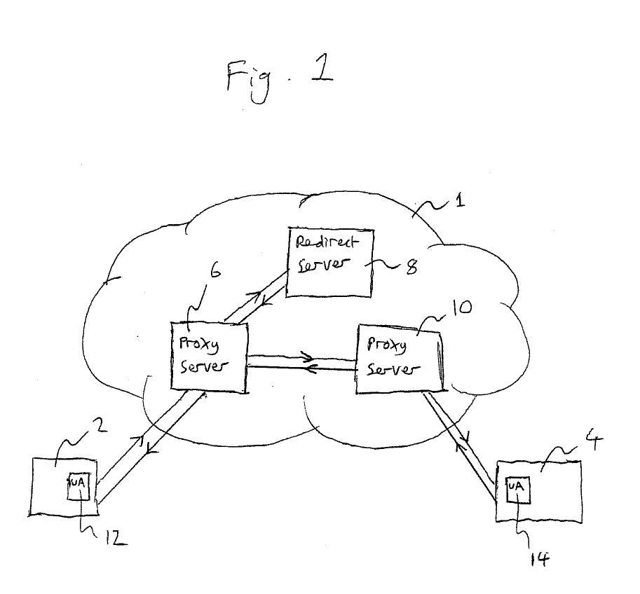

FIG. 1 is a schematic representation of an exemplary communications network for initiating a communication session;

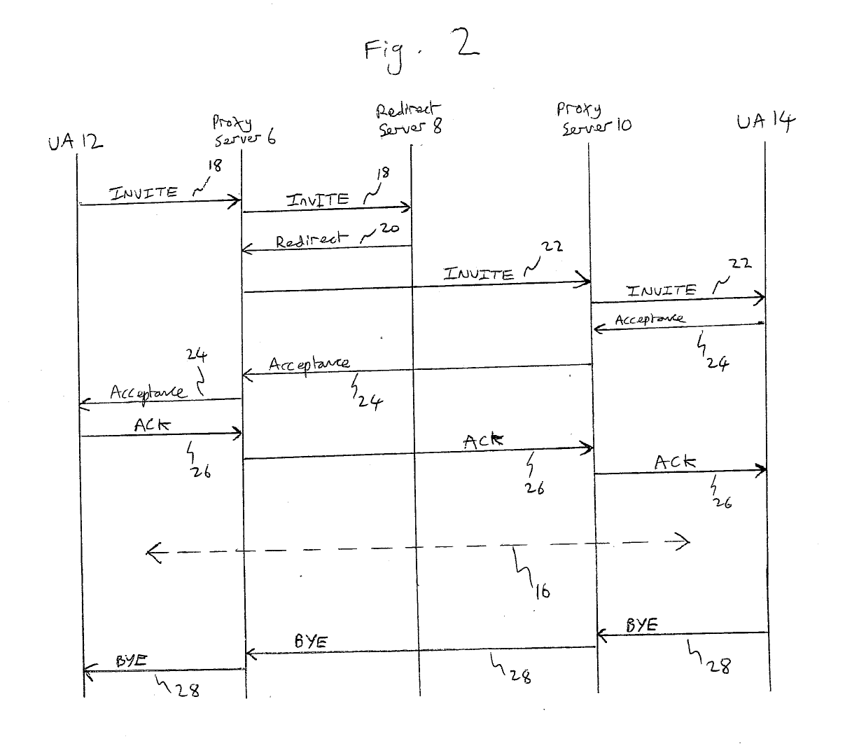

FIG. 2 is a signalling diagram illustrating the initiation of the exemplary session of FIG. 1;

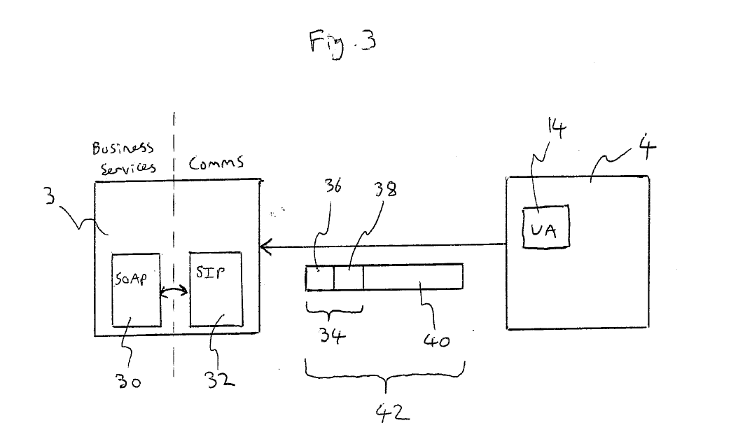

FIG. 3 is a schematic representation of a transport method according to one embodiment of the present invention;

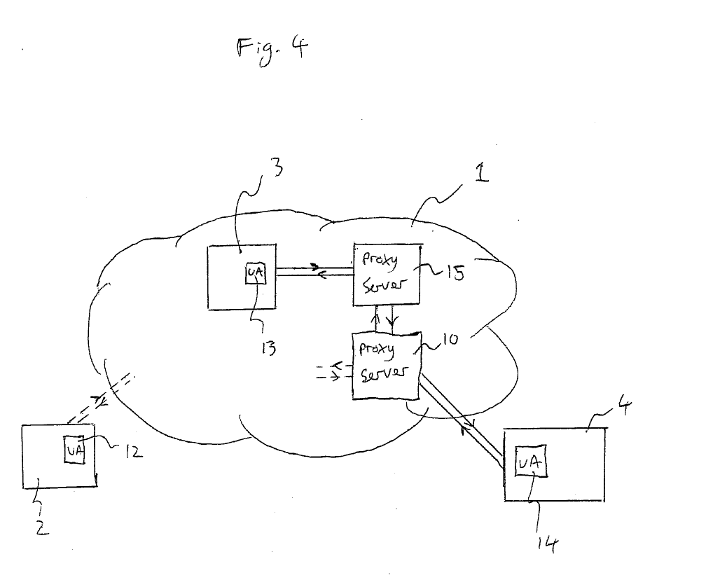

FIG. 4 shows the network of FIG. 1 with additional components for performing services according to an embodiment of the present invention; and

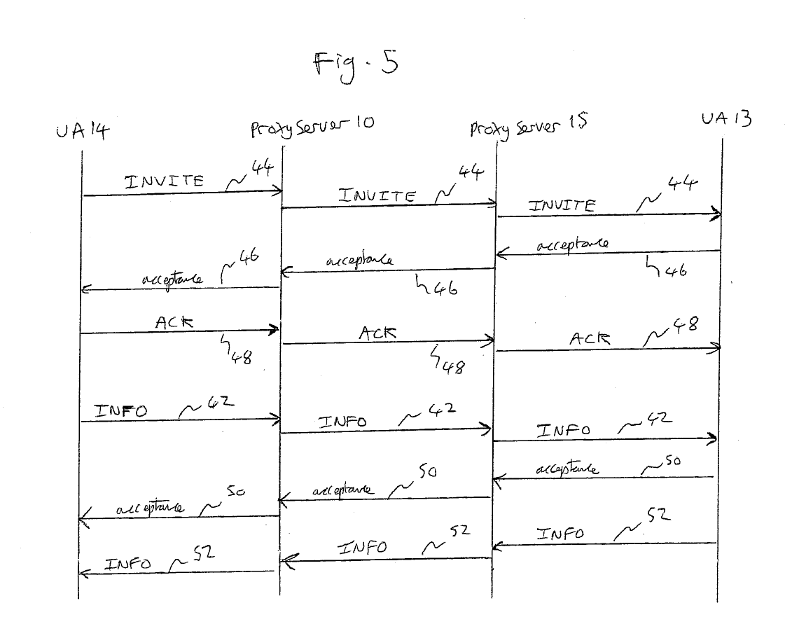

FIG. 5 is a signalling diagram illustrating the exemplary services of FIG. 5.

An example of how a session might be established using SIP is now described with reference to FIGS. 1 and 2.

FIG. 1 shows an exemplary communications network 1 such as the Internet. Endpoint nodes 2 and 4 are in communication with the network 1, and each comprises a SIP user agent (UA) 12 and 14 respectively. A SIP user agent is an application for handling and interacting with SIP services. Also shown, for the purposes of this example, are a proxy server 6 in communication with the UA 12, a redirect server 8 in communication with the proxy server 6, and a proxy server 10 in communication with the UA 14. Proxy servers and redirect servers are key SIP server types, but a person skilled in the art will readily appreciate that SIP interactions can also occur between other types of network element such as SIP/H.323 gateways, SIP/PSTN gateways and SIP based Application Service Brokers (ASBs). The user terminals 2 and 4 could be for example desktop computers, IP-telephones, personal digital assistants (PDAs), or such like.

To initiate a session, UA 12 transmits a SIP request message of the INVITE type to the proxy server 6. The INVITE request contains the address of the sender and the address of the intended recipient, in this case the endpoint nodes 2 and 4 respectively. The INVITE acts as an indication that the sender wishes to establish a communication session with that recipient. In this example, the proxy server 6 then forwards the INVITE request to the redirect server 8. Instead of forwarding calls, a redirect server asks the requestor to contact another server directly. So here, the redirect server 8 looks up the recipient address in its data base, determines that they should be contacted via proxy server 10, and returns a new address for the recipient in a response message 20. The recipient may have previously informed the redirect server 8 of his redirection address via a REGISTER request type. The proxy server 6 then forwards an amended INVITE request 22 containing the new address to proxy server 10, which in turn forwards it to UA 14. The UA 14 then accepts the session by returning an acceptance response message 24 to the initiating UA 12 via proxy servers 8 and 6. Alternatively, the UA 14 could respond with a rejection, a busy response, an error response, or such like. Assuming the session is accepted, the initiating UA 12 sends an ACK request message 26 to the UA 14 to confirm receipt of the acceptance response 24. The session is then established and data 16 such as voice or instant messages can be exchanged between the two UAs 12 and 14.

The session ends when any of the participants transmits a request message of the BYE type. In this example, the endpoint node 14 wishes to end the session and UA14 transmits a BYE request message 28 to UA 12.

The present invention is particularly concerned with extending the functionality of request messages within a SIP session. The transmission of the INVITE message defines the beginning of the session and the transmission of the corresponding BYE request defines the end of the session. Therefore a request message may be considered to be within a given session if: it is exchanged between the participants of the session, it is identified in its header as being associated with that session, and it occurs after the INVITE request and before the BYE request. The header contains an ID which uniquely identifies the session for both parties.

Note that the above is only an example of how a session could be initiated. In other situations, the redirect server 8 may not be required if the address included in the original INVITE 18 provided by the UA 12 is sufficient to direct it to the destination UA 14. Alternatively, any number of steps may be involved between user terminals, proxy servers, redirect servers, other gateways, brokers or the like. Further, any number of participants and their respective UAs could be involved in the session, such as in the case of a conference call or instant messaging session.

The standard SIP request types are as follows:

INVITE: Indicates that a user is being invited to participate in a session.

ACK: Confirms that the user has received a response to an INVITE request.

BYE: Terminates a call.

CANCEL: Cancels any pending searches but does not terminate an ongoing session.

OPTIONS: Queries the capabilities of a server.

REGISTER: Registers a specified address with a SIP server.

SUBSCRIBE: Subscribes for event notification service.

NOTIFY: Notifies a subscriber of a new event.

INFO: Carries session related control information generated during a session.

REFER: Refers the recipient to a resource provided by the request.

MESSAGE: Transfers instant messages.

UPDATE: Updates parameters of a session.

PRACK: Provides a provisional response acknowledgement.

A preferred transport mechanism according to an embodiment of the present invention is now described with reference to FIG. 3. In FIG. 3, the endpoint node 4 and its associated user agent communicates a SIP message 42 to a server 3. The SIP message comprises a header portion 34 and a body portion 40. The header portion comprises a request portion 38 which defines the SIP message as being of a particular standard SIP request type, in this example the INFO type. The header portion 34 also comprises a further header portion 36 which contains other general standardized header information such as the sender's address, the recipients address, the call-ID and so forth. The details of the SIP headers will be familiar to a person skilled in the art. The body portion 40 of the request 42 contains SOAP vocabulary.

As will be understood by a person skilled in the art, the server 13 may comprise a SIP stack 32 for handling media and communications, and a SOAP stack 30 for handling business and web services. Normally these stacks would function separately, but according to the present invention a binding is provided between the stacks allowing SOAP vocabulary 40 received in SIP message 42 to be processed by the SOAP stack.

In a preferred embodiment, the SOAP vocabulary is transported in the body of an INFO request message. The useful property of the INFO message is that when a user agent detects an INFO message, it knows to look to the body of the message for information, without any particular expectation as to what type of information may be contained therein. That is, a SIP user agent may understand and process an INFO request, but have no knowledge of the processing rules for the body. By including SOAP vocabulary in the body of the SIP message and binding it to the SOAP stack, additional functions can be added to the SIP session and transported via SIP messages. So INFO is used to transmit information about the session. The INFO method is not used to change the state of SIP calls, or the parameters of the sessions SIP initiates. Instead it sends optional application-layer information, generally related to the session. Because the information is optional and not related to session management, it provides a suitable conduit for point to point transmissions outside the media path. INFO is defined in IETF standard RFC2976.

Note that because of the generic nature of the INFO message, other INFO messages may well also be transmitted containing information other than SOAP vocabulary.

Another advantageous embodiment includes SOAP vocabulary in the body of a MESSAGE request type. MESSAGE is used for Instant Messaging (IM) text. In principle the SOAP vocabulary could be included in the body of any request type. The above request types are already standardized, and so can be recognized by any SIP user agent UA and thus can advantageously be used according to the present invention. The invention seeks to avoid any non-standardized modification to the header portion of the request.

SOAP is a particularly advantageous protocol to use to extend SIP, because SOAP is a program-level specification that provides a meta-model for defining new services. That is, SOAP provides a schema for specifying new formats for sending data. Further, in contrast with regular SIP, SOAP is particularly suited to providing business and web services. SOAP is also well suited to system-system interactions such as between two servers. This is because SOAP establishes a standard grammar for accessing business services, by providing a standard defining how to request services, including how to encode data parameters required to interact with a service.

SOAP development is simplified by complementary standards and vendor support. For example WSDL complements SOAP with a standard for defining of services exposed via SOAP and for expressing the data types used to access the service. SOAP has broad tool vendor support. For example, a SOAP programming model has been introduced into the Microsoft VisualBasic and C# programming languages as part of the Microsoft .NET Framework.

An example of providing an extended service within a SIP session according to the present invention is now described with reference to FIGS. 4 and 5. In this example, the endpoint node 2 is a personal digital assistant (PDA) and the endpoint node 4 is the server of a bank. It is assumed for the purpose of this example that the PDA 2 and server 4 have already established a banking session in a manner such as described above with reference to FIGS. 1 and 2.

The user of the PDA then wishes to take advantage of some service that requires the bank to have access to up-to-date interest rates, which the bank provides off-site from a separate server 3. Accordingly, the UA 14 of the bank's server 4 invites the off-site server 3 to join the session by transmitting an INVITE request 44 to it's UA 13. The UA 13 accepts the invitation with an acceptance message 46, and the UA 14 acknowledges the response with an ACK request 48. All such messages are forwarded via proxy servers 10 and 15.

Once the UA 13 has thus joined the session, UA 14 transmits an INFO message 42 which contains SOAP vocabulary for requesting the interest data for the user in question. In this example, the SOAP vocabulary is used to define a new function called “GetInterestRates”. No such function could be available using regular SIP. Accordingly, the INFO request 42 might have a format along the following lines:

```
INFO sip:example.net SIP/2.0
To: server3@example.net
From: server4@example.net
Call-ID: 123456@192.123.45.67
CSeq: 12 INFO
Via: proxy@example.net
Content-Type: text/xml
Content-Length 316
<?xml version=“1.0”?>
<soap:Envelope
xmlns:soap=“http://www.w3.org/2001/12/soap-envelope”
soap:encodingStyle=“http://www.w3.org/2001/12/soap-encoding”>
  <soap:Body xmlns:m=“http://www.example.net/rates”>
    <m:GetInterestRates>
      <m:UserRates>IBM</m:UserRates>
    </m:GetInterestRates>
  </soap:Body>
</soap:Envelope>
```

The server 3 is thus requested to provide the relevant data. For consistency with the SIP specification and INFO request type specification, server 3 first replies to the request with a 200OK response 50, and then returns data for the SOAP request in a new INFO message 52. This second request might have the following format:

```
INFO sip:example.net SIP/2.0
To: server4@example.net
From: server3@example.net
Call-ID: 123456@192.123.45.67
CSeq: 13 INFO
Via: proxy@example.net
Content-Type: text/xml
Content-Length 344
<?xml version=“1.0”?>
<soap:Envelope
xmlns:soap=“http://www.w3.org/2001/12/soap-envelope”
soap:encodingStyle=“http://www.w3.org/2001/12/soap-encoding”>
  <soap:Body xmlns:m=“http://www.example.net/rates”>
    <m:GetInterestRatesResponse>
      <m:Rates>5,7,12</m:Rates>
    </m:GetInterestRatesResponse>
  </soap:Body>
</soap:Envelope>
```

Advantageously, because the present invention uses a media session based protocol such as SIP, the above type of functionality can be introduced into a media session, for example into a voice or video call with a bank employee.

Of course, the above is only an example of one of many possible services that could be implemented according to the teachings of the present invention. In another advantageous embodiment, the invention could be used to provide billing information to a user's telephone or desktop computer after the user has ended a voice or video call. Other examples could include checking a user's credit status, requesting stock quotes, or practically anything else.

The above example has been described with reference to Session Initiation Protocol (SIP). However, it will be appreciated by a person skilled in the art that the teachings of the invention could be extended to any session based protocol whereby it is desirable to extend the functionality of that protocol without breaking industry standards. Similarly, although the above example has been described with reference to Simple Access Object Protocol (SOAP), it will be appreciated that the teachings of the invention could be extended to take advantage of any protocol that provides a model or schema for defining new services. The scope of the present invention should not be limited to the above embodiment, but instead with reference to the following claims:

1. A method of transmitting data in a communication network comprising a first node and a second node, the method comprising:
initiating a communication session according to a first predetermined communication standard, wherein the first predetermined communication standard is a session-based protocol for establishing and controlling media sessions; and
transmitting from the first node to the second node, within said session, a first message comprising a header portion and a body portion, the header portion being configured according to the first predetermined communication standard;
wherein the body portion comprises data configured according to a second communication standard, the second communication standard providing a schema for creating methods of requesting service functions.

2. The method of claim 1, wherein said first node is configured according to the predetermined settings of a first provider and said second node is configured according to the predetermined settings of a second provider, wherein each of said first provider and said second provider is one of a manufacturer, a network operator and a network service provider; and
wherein said predetermined settings are such that each of said first node and said second node is configured to recognise both said first communication standard and said second communication standard.

3. The method of claim 1, wherein said first predetermined communication standard defines a message of a predetermined type and said first message is a message of that predetermined type.

4. The method of claim 3, wherein the second node is configured to be instructed, upon detecting any message to be of said predetermined type, to refer to the body of said any message for generic information, the referral being independent of the content of the body of said any message.

5. The method of claim 3, wherein the method comprises a step of transmitting a second message of said predetermined type, the second message comprising a header portion and a body portion, wherein the body of the second message does not comprise data configured according to said second communication standard.

6. The method claim 1, wherein the header portion of the first message comprises a request portion defining the request type and a further header portion containing additional header information.

7. The method of claim 1, wherein each of the first and second nodes comprises a server.

8. The method of claim 1, further comprising a step of ending said session by transmitting an end message of the first communication protocol, the transmission of the end message defining the end of the session.

9. The method of claim 1, wherein the first communication standard is an application-layer protocol.

10. The method of claim 1, wherein the first communication standard is a session-based protocol for establishing and controlling at least one of a voice session, an instant messaging session, and a video session.

11. The method of claim 1, wherein the session is one of a voice session, an instant messaging session, and a video session.

12. The method of claim 1, wherein the first communication standard is Session Initiation Protocol (SIP).

13. The method of claim 1, wherein the second communication standard provides a specification for creating methods of requesting services, including for defining how to encode data parameters required to interact with a service.

14. The method of claim 1, wherein the second communication standard is Simple Object Access Protocol (SOAP).

15. The method of claim 3, wherein said predetermined message type is an INFO message type.

16. The method of claim 3, wherein said predetermined message is a MESSAGE message type.

17. The method of claim 3, wherein said predetermined message is one of the following message types: INVITE, REGISTER, BYE, ACK, CANCEL, OPTIONS, REFER, SUBSCRIBE, NOTIFY, MESSAGE, UPDATE and INFO.

18. A first network element for transmitting data over a communication network to second network element, the first network element being arranged to:
initiate a communication session according to a first predetermined communication standard by transmitting an invitation message to the second network element, wherein the first predetermined communication standard is a session-based protocol for establishing and controlling media sessions; and
transmit to the second network element, within said session, a first message comprising a header portion and a body portion, the header portion being configured according to the first predetermined communication standard;
wherein the first network element is further arranged to insert data configured according to a second communication standard into said body portion prior to transmission, the second communication standard providing a schema for creating methods of requesting service functions.

19. A second network element for receiving data over a communication network from a first network element, the second network being arranged to:
join a communication session according to a first predetermined communication standard upon receipt of an invitation message from the first network element, wherein the first predetermined communication standard is a session-based protocol for establishing and controlling media sessions; and
receive from the first network element, within said session, a first message comprising a header portion and a body portion, the header portion being configured according to the first predetermined communication standard;
wherein the body portion comprises data configured according to a second communication standard, the second communication standard providing a schema for creating methods of requesting service functions; and
the second network element is arranged to extract the data configured according to the second communication standard.

20. A second network element according to claim 19 comprising a first stack configured according to the first predetermined communication standard and a second stack configured according to the second predetermined communication standard, wherein the second network element is configured to provide a binding between the first stack and the second stack.
